(19) United States
(12) Patent Application Publication
(10) Pub. No.: US 2016/0245377 A1
(43) Pub. Date: Aug. 25, 2016

(54) FLYWHEEL-DRIVEN AUXILIARY DEVICE

(71) Applicant: Albert Roy Polsfut, Biggar (CA)

(72) Inventor: Albert Roy Polsfut, Biggar (CA)

(21) Appl. No.: 15/045,307

(22) Filed: Feb. 17, 2016

Related U.S. Application Data
(60) Provisional application No. 62/117,334, filed on Feb. 17, 2015.
(60) Provisional application No. 62/136,453, filed on Mar. 21, 2015.

(51) Int. Cl. F16H 13/10; B60K 25/02; F16H 13/02

(52) U.S. Cl. CPC F16H 13/10; F16H 13/02; B60K 25/02

(57) ABSTRACT

An arrangement whereby the shaft of a pump is positioned against the edge, of a flywheel of a stationary or portable engine, with direct contact between the flywheel edge and the pump shaft, such that rotation of the flywheel imparts rotation to the shaft and thus powers the pump. A housing or similar support structure holds the pump in position against the flywheel edge. The arrangement eliminates the conventional need for a belt connection between the engine and the pump.

### FIELD OF THE INVENTION

The present invention relates generally to powering auxiliary devices, and particularly to means for imparting rotation to a pump shaft.

### BACKGROUND OF THE INVENTION

It is well known to locate stationary engines beside oil pump equipment such as pump jacks. These stationary engines are used to power the pump jacks themselves through belt connections, but also to supply power to auxiliary equipment such as pumps. Commonly used stationary engines have a clutch assembly on one side with a four-groove pulley. A conventional arrangement comprises connecting the pulley to the pump jack by means of continuous belts run in three of the grooves, while a belt is run through the fourth groove to connect to the shaft of an auxiliary pump, such that rotation of the pulley transfers torque through the belt to the shaft.

In cold climates, equipment and lines around a pump jack can freeze, and it has become common to employ heat tracing technology to circulate heated fluid to thaw the equipment and lines. The fluid circulation is conventionally enabled by an auxiliary pump, which pump is driven by a belt from a pulley on the stationary engine. In warmer climates, an auxiliary pump can be used to circulate a coolant fluid in a similar manner.

In order to run such an auxiliary pump, the belts used to power the pump jack must first be removed from the pulley. The belt for the auxiliary pump is then put in place and the pump is used to circulate the fluid. However, it is well known that the switching of belts can be dangerous and may cause injury to an operator's hands. It is not unknown for operators to lose fingers when switching belts.

What is needed, therefore, is a means for powering auxiliary equipment using a stationary engine, while reducing the risk of injury from belt switching.

The present invention therefore seeks to provide an arrangement in which the shaft of a pump is brought into contact with the edge of a flywheel on the engine, to impart rotation to the shaft without the use of a belt.

According to one broad aspect of the present invention, there is provided an arrangement comprising:
an engine comprising a flywheel, the flywheel having a peripheral, edge;
an auxiliary device comprising a rotating shaft; and
a housing for retaining the auxiliary device, the housing configured to press the shaft of the auxiliary device against the peripheral edge of the flywheel;
such that rotation of the flywheel imparts torque to the shaft of the auxiliary device to rotate the shaft.

In some exemplary embodiments of the present invention, an intervening torque transfer device could be inserted between the flywheel peripheral edge and the shaft. For example, this could be an idler. In some further exemplary embodiments, biasing means may be necessary to press the shaft against the peripheral edge of the flywheel.

A detailed description of an exemplary embodiment of the present invention is given in the following. It is to be understood, however, that the invention is not to be construed as being limited to this embodiment.

### BRIEF DESCRIPTIONS OF THE FIGURES

In the accompanying Figures, which illustrate an exemplary embodiment of the present invention:

FIG. 1 is a bottom perspective view of a pump according to an exemplary embodiment of the present invention; and

FIG. 2 is a top perspective view of the pump of FIG. 1 held against the edge of a flywheel according to an exemplary embodiment of the present invention.

An exemplary embodiment of the present invention will now be described with reference to the accompanying Figures.

### DETAILED DESCRIPTION OF EXEMPLARY EMBODIMENT

Throughout the following description specific details are set forth in order to provide a more thorough understanding to persons skilled in the art. However, well known elements may not have been shown or described in detail to avoid unnecessarily obscuring the disclosure. The following description of an example of the invention is not intended to be exhaustive or to limit the invention to the precise form of the exemplary embodiment. Accordingly, the description and Figures are to he regarded in an illustrative, rather than a restrictive, sense.

Flywheels are commonly used to store rotational energy, as they resist changes in rotational speed due to their moment of inertia. Energy is applied to a fly wheel to increase its rotational speed and stored energy. To release the stored energy, the flywheel is used to apply torque to a mechanical load. It is well known that stationary or portable engines incorporate flywheels. According to the exemplary embodiment, a flywheel of a stationary engine is used to rotate an auxiliary pump shaft through direct contact.

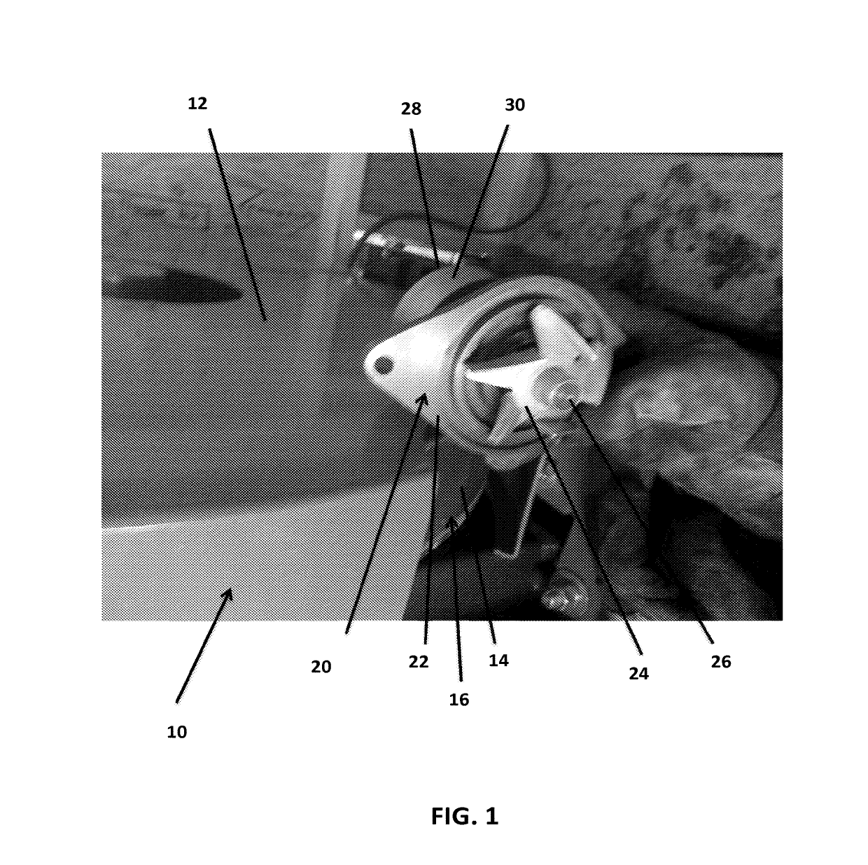

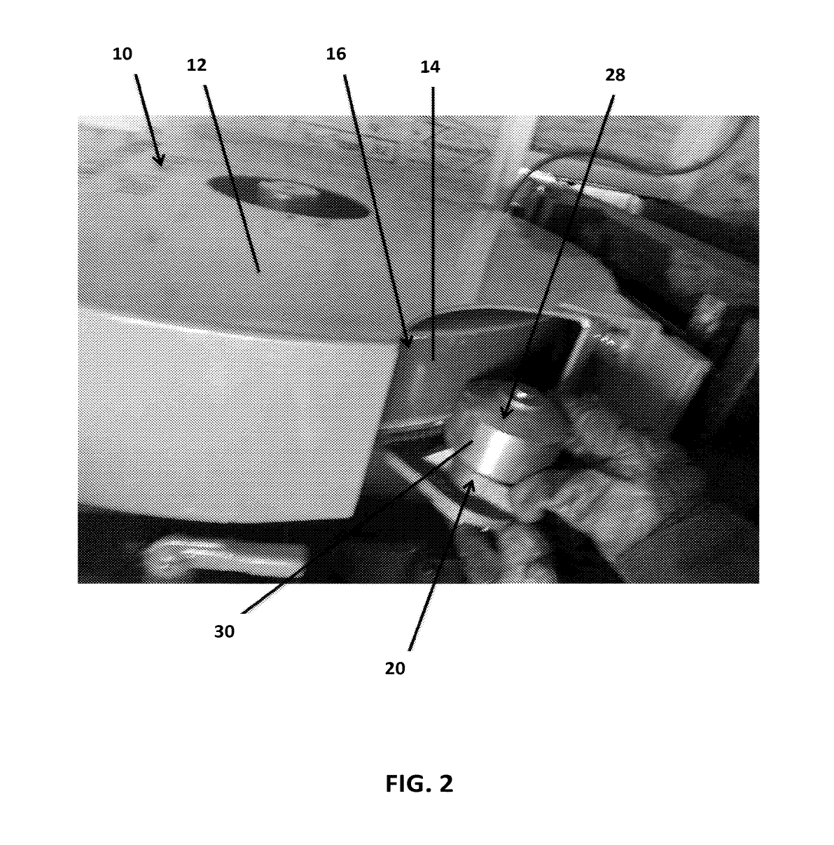

Turning now to FIGS. 1 and 2, an exemplary embodiment of the present invention is illustrated. A conventional flywheel arrangement 10 is shown, which comprises a cover 12, a flywheel 16 disposed within the cover 12, and an aperture in the cover to enable access to the flywheel 16. The flywheel 16 is provided with a peripheral edge 14 that is parallel to the axis of rotation.

An auxiliary device is also illustrated, in this embodiment a conventional impeller-type pump 20. As can be seen in bottom perspective view in FIG. 1, the pump 20 comprises a base 22 for mounting to a support structure (not shown), and an impeller 24 mounted on a rotatable shaft 26.

In the top perspective view of FIG. 2, it can be seen that the pump 20 also comprises a widened portion 28, which widened portion 28 has a peripheral surface 30 parallel to the axis of rotation of the shaft 26. In some other embodiments, the widened portion 28 may be absent, such that the peripheral surface 30 would be that of the main shaft 26 itself.

As can be seen in FIG. 2, the peripheral surface 30 of the widened portion 28 of the shaft 26 is positioned against the peripheral edge 14 of the flywheel 16. By aligning the surface 30 and the peripheral edge 14 and pressing them together as shown, so that they are in full surface contact with the flywheel 16 and pump shaft 26 axes of rotation parallel, rotation of the flywheel 16 imparts torque to the widened portion 28, thus rotating the shaft 26 and the impeller 24. The pump 20 can thus be powered without the conventional use of a belt between an engine pulley and the shaft 26.

The pump 20 is shown as being held by the operator, but in use the pomp 20 would instead be retained within a housing or similar support structure. As the size and configuration of the housing would vary from one application to another, this has not been illustrated. Those skilled in the art would be able to readily provide an appropriate housing to hold the peripheral surface 30 of the shaft 26 against the peripheral edge 14 of the flywheel 16. Such a housing would hold the shaft 26 at a proper height and orientation to align correctly with the peripheral edge 14 of the flywheel 16, and would also allow free rotation of the shaft 26. The housing would provide whatever other structural features were necessary for use of the pump 20, as would be clear to those skilled in the art.

In addition, the housing would be provided with means to ensure contact between the peripheral surface 30 of the shaft 26 and the peripheral edge 14 of the flywheel 16. This may require some form of biasing known in the field, and again those skilled in the art would be readily able to provide such a feature if necessary.

In operation, then, an operator would determine whether it was necessary to run the pump 20. This might be the case, for example, where equipment and/or lines adjacent a pump jack have become frozen due to ambient winter conditions and the pump 20 is used to circulate heating fluid in a heat tracing arrangement. Having determined that operation of the pump 20 is necessary or desirable, the operator would position the pump 20 adjacent the flywheel 16 using the housing. The operator would ensure that the peripheral surface 30 of the widened portion 28 of the shaft 26 was pressed into surface contact with the peripheral edge 14 of the flywheel 16. The flywheel 16 would then be rotated to impart torque to the shaft 26, rotating the impeller 24 and thus circulating the heated fluid to thaw the equipment and/or lines.

When installing the exemplary embodiment at an existing pump site, the first step would be to exhaust any stored energy within the pump jack weight system. The engine clutch would be disengaged and any stored energy exhausted from the pump jack. Then the hand brake of the pump jack would be applied, thus stopping any movement towards the engine. The engine would then be shut down, ensuring that it comes to a full stop position. The fuel gas would be shut off and the engine allowed to cool to a safe working temperature to prevent operator burns. Once cooled, the operator would then install the housing and the pump. Following installation these steps can be reversed to start the unit up again. The pump can be run continuously, with the circulated fluid topped up as necessary. The belts from the clutch assembly pulley to the pump jack thus do not need to be removed to install and operate the exemplary embodiment of the present invention.

As can be seen, then, the exemplary embodiment eliminates the need for a continuous belt connection, and thus the inherent injury risk from changing belts during operation. In addition, the impeller 24 can be rotated at higher rpm than is conventional, thus potentially improving the efficiency of the pump 20.

While the exemplary embodiment has been described as being useful in the context of pump jack equipment, the present invention can be used with numerous other applications where stationary engines with flywheels are employed.

As will be clear from the above, those skilled in the art would be readily able to determine obvious variants capable of providing the described functionality, and all such variants and functional equivalents are intended to fail within the scope of the present invention. For example, it may be appropriate in certain circumstances to insert an intervening component such as an idler between the pump and the flywheel, and those skilled in the art would be able to identify such a situation and readily apply an appropriate component. As a further example, in certain circumstances it may be possible or even desirable to have the pump shaft contact an upper or lower surface of the flywheel adjacent the edge, but not contact the edge itself.

A specific example has been described herein for purposes of illustration. This is only an example. The technology provided herein can be applied to contexts other than the exemplary context described above. Many alterations, modifications, additions, omissions and permutations are possible within the practice of this invention. This invention includes variations on the described embodiment that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or emitting combining features, elements and/or acts from described embodiments.

The foregoing is considered as illustrative only of the principles of the invention. The scope of the claims should not be limited by the exemplary embodiment set forth in the foregoing, but should be given the broadest interpretation consistent with the specification as a whole.

1. An arrangement for powering an auxiliary device, the arrangement
comprising:
an engine comprising a flywheel;
the auxiliary device comprising a rotatable shaft;
torque transfer means positioned between the flywheel and the shaft; and
a support member for retaining the auxiliary device such that the shaft engages the torque transfer means;
such that rotation of the flywheel imparts torque through the torque transfer means to the shaft to rotate the shaft.

2. The arrangement of claim 1 wherein the torque transfer means is an idler.

3. An arrangement for powering an auxiliary device, the arrangement
comprising:
an engine comprising a flywheel;
the auxiliary device comprising a rotatable shaft; and
a support member for retaining the auxiliary device such that the shaft directly engages the flywheel;
such that rotation of the flywheel imparts torque to the shaft to rotate the shaft.

4. The arrangement of claim 3 further comprising bias means for pressing the shaft against the flywheel.

5. The arrangement of claim 3 wherein the support member is configured to press the shaft against the flywheel.

6. The arrangement of claim 3 wherein the flywheel comprises a peripheral edge, an upper surface and a lower surface.

7. The arrangement of claim 6 further comprising bias means for pressing the shaft against the peripheral edge, the upper surface or the lower surface of the flywheel.

8. The arrangement of claim 7 wherein the bias means is for pressing the shaft against the peripheral edge of the flywheel.

9. The arrangement of claim 6 wherein the support member is configured to press the shaft against the peripheral edge, the upper surface or the lower surface of the flywheel.

10. The arrangement of claim 9 wherein the support member is configured to press the shaft against the peripheral edge of the flywheel.

11. The arrangement of claim 1 wherein the support member is a housing.

12. The arrangement of claim 1 wherein the auxiliary device is an auxiliary pump.

13. The arrangement of claim 12 wherein the auxiliary pump is for circulating heating fluid.

14. The arrangement of claim 12 wherein the auxiliary pump is for circulating coolant fluid.

15. The arrangement of claim 3 wherein the rotating shaft comprises a widened portion, such that the rotation of the flywheel imparts torque to the widened portion of the shaft to rotate the shaft.

16. A method for rotating a shaft of an auxiliary device; the method comprising the steps of: providing the auxiliary device;
providing an engine comprising a flywheel;
retaining the auxiliary device with a support member such that the shaft engages the flywheel; and
operating the engine causing the flywheel to rotate, such that the rotation of the flywheel imparts torque to the shaft to rotate the shaft.

17. The method of claim 16 wherein the shaft indirectly engages the flywheel and the rotation of the flywheel imparts torque through torque transfer means to the shaft to rotate the shaft.

18. The method of claim 16 wherein the shaft directly engages the flywheel.

19. The method of claim 18 further comprising the step of pressing the shaft against the flywheel using bias means.

20. The method of claim 18 further comprising the step of pressing the shaft against the flywheel, wherein the support member is configured to press the shaft against the flywheel.

21. The method of claim 16 wherein the auxiliary device is an auxiliary pump.

22. The method of claim 21 further comprising the step of circulating heating fluid using the auxiliary pump.

23. The method of claim 21 further comprising the step of circulating cooling fluid using the auxiliary pump.
